(19) United States
(12) Patent Application Publication
(10) Pub. No.: US 2006/0028713 A1
(43) Pub. Date: Feb. 9, 2006

(54) Optical imager for the 3-5 micron spectral band

(76) Inventor: John M. Hall, Amherst, NH (US)

Correspondence Address: DEPARTMENT OF THE ARMY, AMSEL LG P NVEO, 10225 BURBECK ROAD, FORT BELVOIR, VA, 22060-5806, US

(21) Appl. No.: 10/911,475

(22) Filed: Aug. 5, 2004

(51) Int. Cl. G02B 13/14

(52) U.S. Cl. 359/357; 359/350

(57) ABSTRACT

An optical imager for use in the 3-5 micron spectral band. The imager comprises a large aperture positively-powered first objective lens made of a first material for collecting collimated light, and a slightly negatively-powered second objective lens made of a second material spaced behind the first objective lens to provide a color-corrected intermediate focal plane for the collected light. The imager further includes a relay group of three lenses disposed behind the second objective lens for re-imaging the intermediate focal plane.

### GOVERNMENT INTEREST

The invention described herein may be manufactured, used, sold, imported, and/or licensed by or for the Government of the United States of America.

### BACKGROUND OF THE INVENTION

This invention relates in general to optical devices, and more particularly, to optical imaging systems.

Infra-red optics has been in use by the military for several years, and commercial applications continue to grow. While most of the military development has concentrated on sensors operating in the 8-12 micron spectral band, the advent of large pixel density “staring” detector arrays using materials such as Indium Antimonide (InSb) requires the use of optics designed specifically for the 3-5 micron spectral band. Since these detectors are cryogenically cooled, it is important to provide imaging optics which match the “cold shield” aperture stop within the cryogenic Dewar assembly. For many of the 3-5 micron sensors in existence today, a popular approach is the use of hybrid reflective/refractive catadioptric imaging optics. These have the advantage of obtaining a long focal length within a relatively small package size. However, they suffer from a central obscuration in the entrance pupil. For shorter focal lengths and larger fields of view, a typical approach is to use a simple imaging objective lens assembly.

### SUMMARY OF THE INVENTION

It is therefore an object of this invention to provide an improved design for an imager in the 3-5 micron spectral band.

This and other objects of the invention are achieved in one aspect by an optical imager for use in the 3-5 micron spectral band. The imager comprises a large aperture positively-powered first objective lens made of a first material for collecting collimated light, and a slightly negatively-powered second objective lens made of a second material spaced behind the first objective lens to provide a color-corrected intermediate focal plane for the collected light. The imager further includes a relay group of three lenses disposed behind the second objective lens for re-imaging the intermediate focal plane.

Another aspect of the invention involves a method of imaging for use in the 3-5 micron spectral band comprising the steps of collecting collimated light with a large aperture positively-powered first objective lens made of a first material, providing a color-corrected intermediate focal plane for the collected light with a slightly negatively-powered second objective lens made of a second material spaced behind the positively-powered lens, and re-imaging the intermediate focal plane with a relay group of three lenses disposed behind the second objective lens.

The optical imager is an all refractive, “re-imaging” device that allows a long focal length and yet still maintains a small package size. The optical imager provides a fully cold shielded aperture stop, and a projected entrance pupil on the first lens in order to keep size minimal. Diffraction limited resolution as characterized by Modulation Transfer Function (MTF) is achieved by use of a single aspheric surface on the first objective lens element. A further benefit over the typical catadioptric approach is that the all-refractive optics do not suffer from a central obscuration in the entrance pupil. This allows full 100% cold shield efficiency and avoids losses in mid and high frequency MTF that result from the diffraction pattern caused by an obscuration.

Additional advantages and features will become apparent as the subject invention becomes better understood by reference to the following detailed description when considered in conjunction with the accompanying drawings wherein:

### BRIEF DESCRIPTION OF THE DRAWINGS

FIG. 1 shows an embodiment of the optical imager in accordance with the invention.

FIG. 2 is a graphical plot of the Modulation Transfer Function for the optical imager of FIG. 1.

### DETAILED DESCRIPTION

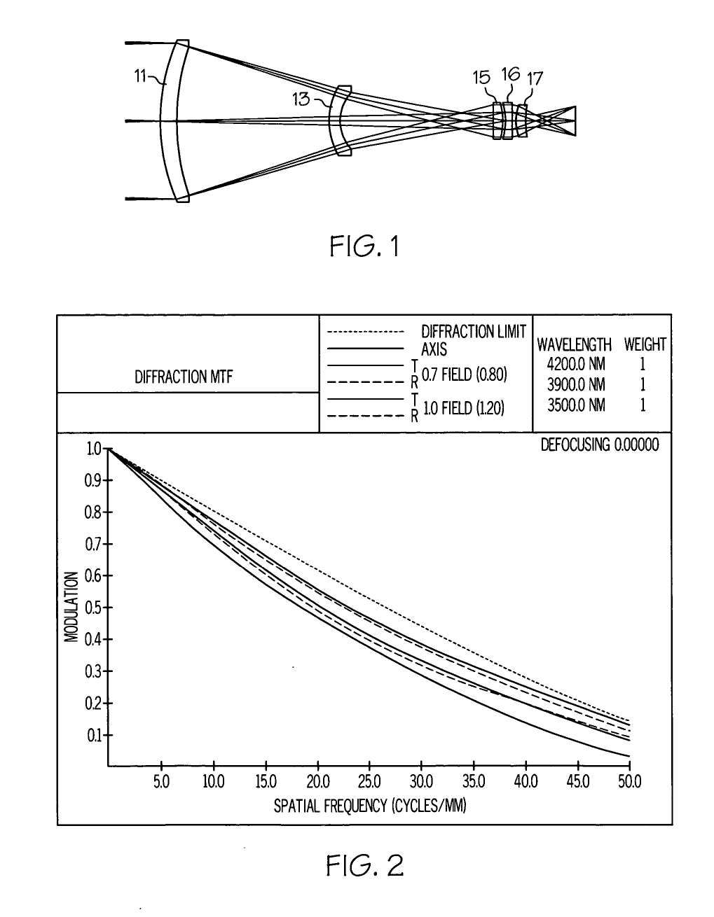

FIG. 1 shows the optical imager and an optical ray-trace. Collimated light enters from the left side into the large aperture objective lens 11. The lens 11 is a positively-powered element made of optical silicon with an aspheric surface for aberration correction. It is followed by a lens 13, which is slightly negatively-powered and made of a different material, calcium fluoride, thus providing a color-corrected intermediate focal plane. The lens 13 may be affixed to a linear slide mechanism and used to accomplish range focus for near-field targets as well as focus compensation over temperature if desired. The focal plane is then re-imaged into the detector Dewar assembly by way of a group of three lenses 15-17, consisting of silicon, calcium fluoride, and then silicon lens elements, all of which have either planar or spherical surfaces. This relay group provides a pupil at the cold stop location in a typical Dewar, which is about 25 mm away from the detector focal plane location.

Table 1 provides the surface description data, showing the relative location of each lens and the air spacing to the next. The radii of curvature for the surfaces of the last of the three lenses 15-17 in the relay group can be further optimized to have identical values, if desired by the lens manufacturer. Table 2 lists both the material indices of refraction and the aspheric surface coefficients, which generate a rotationally symmetric shape according to the following sag equation:

$$z = \frac{c {h}^{2}}{1 + {[ 1 - ( 1 + k ) {c}^{2} {h}^{2} ]}^{1 / 2}} + A {h}^{4} + B {h}^{6} + C {h}^{8} + D {h}^{10}$$

Where z is the sag of the surface parallel to the optical axis, c is the surface curvature defined as the reciprocal of the radius, h is the radial aperture height about the optical axis, k is the conic constant, and A, B, C, and D are the general aspheric coefficients. Table 3 lists the first order parameters of the lens system, which features a 440 mm focal length (the negative sign indicating an inverted image), speed of F#/4.0, and an overall length slightly less than ten inches. The lens assembly will provide a field of view of at least 1.2° on a typical 640×480 element detector with 28 micron pitch.

FIG. 2 shows a plot of the Modulation Transfer Function for the lens assembly, which is seen to be nearly diffraction limited across most of the field of view. Note that this design does not suffer from losses in mid and high frequency MTF due to the physical diffraction effects causes by a catadioptric central aperture obscuration typical of the prior art. Distortion of this design is approximately 6%, but successive iterations can reduce the levels to 4% or less if desired. Successive lens optimization can also reduce the lens element thickness of weight reduction is desired. It is interesting to note that this design, although diffraction limited across most of the field of view, suffers from secondary color aberration. This means that the best focus position which gives the smallest spot size is located where the maximum (“red”) and minimum (“blue”) wavelengths come to a best focus, but rays at the center wavelength (“green”) are slightly out of focus. This prevents the approach from achieving diffraction limited color correction much beyond an upper wavelength limit of 4.2 microns. To achieve this end, a variety of other lens materials must be considered.

It is obvious that many modifications and variations of the present invention are possible in light of the above teachings. For example, if a second, wider field of view is desired in addition to the field of view provided here, this design is amenable to a common approach of inserting a small lens group between the first two lenses #1 and #2, which effectively reduces the focal length of the front end objective and couples with the relay group of lenses 13-15. The wide field group can be switched in and out via a variety of mechanisms common to the art, thus providing a dual field of view capability. It is therefore to be understood that within the scope of the appended claims, the invention may be practiced otherwise than as described.

TABLE #1
Surface Data
PPRESCRIPTION DATA

| SURFACE | RADIUS | THICKNESS | GLASS TYPE | NOTES |
|---|---|---|---|---|
| OBJ: | INFINITY | INFINITY | | Dimensions - |
| | | | | mm |
| 1: | 130.60757 | 11.800000 | SILICON | Entrance |
| | | | | Pupil |
| *2: | 174.55093 | 100.000000 | | *Asphere |
| 3: | 48.14180 | 7.000000 | CALCIUM | |
| | | | FLUORIDE | |
| 4: | 29.11897 | 104.975398 | | |
| 5: | INFINITY | 6.000000 | SILICON | |
| 6: | −51.06961 | 1.570005 | | |
| 7: | −34.18364 | 5.000000 | CALCIUM | |
| | | | FLUORIDE | |
| 8: | 202.61255 | 1.000000 | | |
| 9: | 20.00000 | 7.000000 | SILICON | |
| 10: | 20.50679 | 3.409560 | | |
| 11: | INFINITY | 5.000000 | | |
| 12: | INFINITY | 0.000000 | | “Cold” Stop |
| 13: | INFINITY | 25.000000 | | |
| IMG: | INFINITY | 0.000000 | | |

TABLE #2
Refractive Indices and Aspheric Coefficients
REFRACTIVE INDICES VS. WAVELENGTH

| | | | |
|---|---|---|---|
| WAVELENGTH (nm) | 4200.00 | 3900.00 | 3500.00 |
| SILICON | 3.424589 | 3.425864 | 3.428117 |
| CALCIUM FLUORIDE | 1.407713 | 1.410574 | 1.414046 |

ASPHERIC COEFFICIENTS

| Surface # | K | A | B | C | D |
|---|---|---|---|---|---|
| *2 | 1.052675 | −.188714E−07 | −.709104E−12 | −.177136E−15 | 0.108845E−19 |

TABLE #3
First Order Parameters
INFINITE CONJUGATES

| | |
|---|---|
| Effective Focal Length = | −439.9999 |
| F# = | −4.0000 |
| Overall Length = | 252.7550 |
| Paraxial Image Height = | 9.2167 |
| Paraxial Field of View = | 1.2° |
| Entrance Pupil Diameter = | 110.0 |

What is claimed as new and desired to be secured by Letters Patent of the United States is:

1. An optical imager for use in the 3-5 micron spectral band comprising:
a large aperture positively-powered first objective lens made of a first material for collecting collimated light;
a slightly negatively-powered second objective lens made of a second material spaced behind the first objective lens to provide a color-corrected intermediate focal plane for the collected light; and
a relay group of three lenses disposed behind the second objective lens for re-imaging the intermediate focal plane.

2. The optical imager recited in claim 1 wherein the first objective lens has an aspheric surface.

3. The optical imager recited in claim 2 wherein one of the relay group of three lenses has a planar surface.

4. The optical imager recited in claim 2 wherein one of the relay group of three lenses has a spherical surface

5. The optical imager recited in claim 1 including:
a linear slide mechanism affixed to the second objective lens.

6. The optical imager recited in claim 1 wherein the first material is optical silicon.

7. The optical imager recited in claim 1 wherein the second material is calcium fluoride.

8. The optical imager recited in claim 1 wherein the first material is optical silicon and the second material is calcium fluoride.

9. The optical imager recited in claim 1 wherein the relay group of three lenses includes a silicon lens.

10. The optical imager recited in claim 1 wherein the relay group of three lenses includes a calcium fluoride lens.

11. The optical imager recited in claim 1 wherein the relay group of three lenses includes a silicon lens and a calcium fluoride lens.

12. The optical imager recited in claim 1 wherein the relay group of three lenses includes a silicon lens, a calcium fluoride lens, and a silicon lens in series.

13. An optical imager for use in the 3-5 micron spectral band comprising:
a large aperture positively-powered first objective lens of optical silicon for collecting collimated light, the lens having an aspheric surface;
a slightly negatively-powered second objective lens of calcium fluoride spaced behind the positively powered lens to provide a color-corrected intermediate focal plane for the light; and
a three-lens relay group disposed behind the second objective lens for re-imaging the intermediate focal plane, the three lens group including a silicon lens, a calcium fluoride lens, and a silicon lens in series, each one of the three lenses having either a planar or a spherical surface.

14. A method of imaging for use in the 3-5 micron spectral band comprising the steps of:
collecting collimated light with a large aperture positively-powered first objective lens made of a first material;
providing a color-corrected intermediate focal plane for the collected light with a slightly negatively-powered second objective lens made of a second material spaced behind the positively-powered lens; and
re-imaging the intermediate focal plane with a relay group of three lenses disposed behind the second objective lens.

15. The method recited in claim 14 including the step of affixing a linear slide mechanism to second objective lens.

16. The method recited in claim 14 where the first material is optical silicon.

17. The method recited in claim 14 where the second material is calcium fluoride.

18. The method recited in claim 14 wherein one of the lenses in the relay group of three lenses is made from silicon.

19. The method recited in claim 14 wherein one of the lenses in the relay group of three lenses is made from calcium fluoride.

20. The method recited in claim 14 wherein one of the lenses in the relay group of three lenses is made from silicon and another of the lenses is made from calcium fluoride.
